(19) United States
(12) Patent Application Publication
(10) Pub. No.: US 2002/0154098 A1
(43) Pub. Date: Oct. 24, 2002

(54) Locating a position on a display screen

(76) Inventor: Werner Metz, Chandler, AZ (US)

Correspondence Address: Timothy N. Trop, TROP, PRUNER & HU, P.C., 8554 KATY FWY, STE 100, HOUSTON, TX, 77024-1805, US

(21) Appl. No.: 09/836,978

(22) Filed: Apr. 18, 2001

(51) Int. Cl. G09G 5/00

(52) U.S. Cl. 345/173

(57) ABSTRACT

A sequence of spatially located characteristics may be generated to detect the position of a sensor. The sensor associated with a screen display may detect a particular sequence of characteristic values which is unique to a given location. Based on a sequence of detected characteristics, the system may resolve the location of the sensor with respect to the display screen.

### BACKGROUND

This invention relates generally to processor-based systems.

In a variety of applications, it is desirable to locate a position on the display screen. For example, a mouse cursor may be positioned at a desired location and that location may be selected to select a given feature of a software program. Similarly, touch screens enable a screen region to be touched to select an option.

Light pens enable the user to either select a particular icon with the light pen or to “draw” or “paint” on a display screen. Generally, light pens detect a strike of light produced by a pixel of a display screen. The time when the strike is received can be correlated to vertical and horizontal sync signals to appropriately locate the pen on the display screen. In other words, the time delay between the detection of light strike by the light pen and the vertical and horizontal sync signals may be correlated to an X and Y position on the display screen.

However, existing techniques for detecting the position of a light sensor, such as a light pen, with respect to a display screen have been subject to a number of shortcomings. For example, with some display screens, the luminosity may sometimes be insufficient to enable detection. Similarly, black regions on the display screen can not be detected. Also, sensing the position of a red pixel may be difficult.

In some cases, the detection may be augmented by a technique called blue flooding. However, the use of blue flooding simply distorts the existing picture and causes additional problems. Still additional problems with existing light pen detectors arise from cross pixel jitter or shaky pen syndrome. Again, jitter may result in erroneous detection of pen position.

Thus, there is a need for a better way to detect the position of a sensing device on a display screen.

### BRIEF DESCRIPTION OF THE DRAWINGS

FIG. 1 is a schematic depiction of a technique in accordance with one embodiment of the present invention;

FIG. 2 is a schematic depiction of another technique in accordance with another embodiment of the present invention;

FIG. 3 is a block diagram of a processor-based system in accordance with one embodiment of the present invention; and

FIG. 4 is a flow chart for software for implementing one embodiment of the present invention.

### DETAILED DESCRIPTION

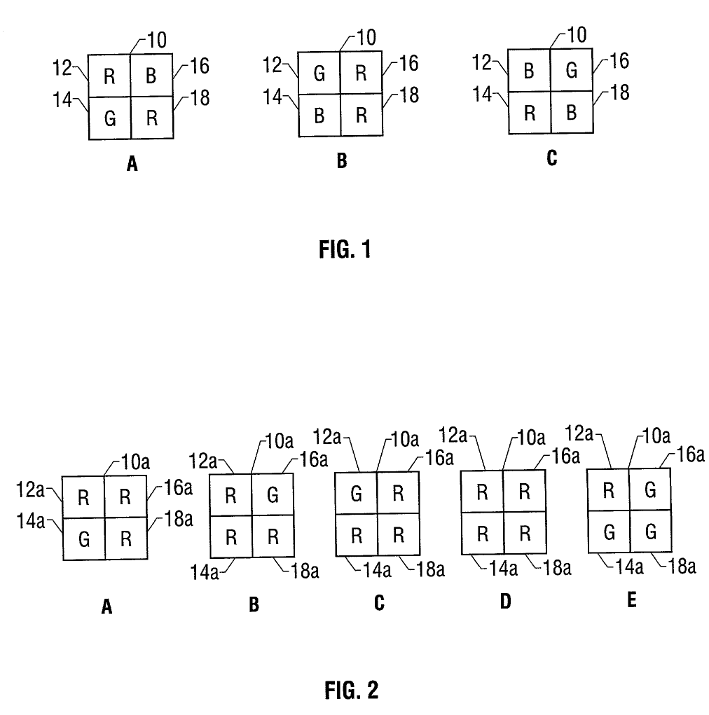

Referring to FIG. 1, a sequence of computer display screen frames 10 are shown. In this case, a frame 10 (or a portion of a frame) may be divided geometrically into a plurality of regions 12 through 18. While the frame 10 is illustrated as being divided into four regions 12-18, any number of regions may be used in other embodiments. In addition, while the regions 12-18 are illustrated as being squares, any other geometric shape may be utilized as well.

Thus, in one embodiment, the overall frame 10 corresponds to a graphical frame of information. Alternatively, the frame 10 may correspond to some portion of a frame. The frame 10 may be divided into regions 12, 14, 16 and 18, each of which is assigned a particular detectable characteristic such as a color value. In FIG. 1, the letter R represents the color red, the letter B represents the color blue, and the letter G represents the color green.

Thus, a system using the red green blue color gamut is illustrated. However, the present invention is applicable to embodiments using any of the variety of available color gamuts. In addition, embodiments of the present invention may be used with gray scale images that use shades of black and white. In such case, unique gray scale values may be ascribed to particular regions 12 through 18.

Each of a plurality of regions 12-18 within a frame 10 are assigned a particular detectable characteristic. This characteristic may be a color, a gray scale value or even a non-visual characteristic such as an infrared or near infrared value. A spatial characteristic may be detected to uniquely determine the location of a sensor tuned to detect that characteristic. The detection of the characteristic may be utilized to determine the position of a sensor such as a light pen.

Thus, referring to FIG. 1, in one embodiment, each of the regions 12 through 18 is assigned one of three different characteristic values at three different times. The three characteristic values create a unique sequence distinguishable from the sequences used in other regions 14-18. For example, at a first instance, shown in the block on the left in FIG. 1, the region 12 is assigned a red value, in the next instance the region 12 is assigned a green value and in the last instance, shown in the block on the right, the region 12 is assigned the blue value. Thus, if a light sensor detects the sequence red-green-blue, there can be no doubt that the light sensor is positioned over the region 12.

A unique sequence of three colors may be selectively assigned to each of the four regions 12-18 at three different time periods to create a sequence that uniquely identifies one of four regions 12-18. The region 12 may be associated with the sequence R-G-B, the region 14 may be associated with the sequence G-B-R, the region 16 may be associated with the sequence B-R-G, and the region 18 may be associated with the sequence R-R-B in one embodiment. Thus, while the characteristic, such as a color, of any region may not in itself be unique, a unique time sequence is assigned to each of the regions 12-18 to enable each region to be uniquely identified. A sensor that senses the unique sequence is necessarily situated over the corresponding region 12-18.

Once the location of the sensor is identified with respect to a region 12-18, the corresponding region may then be resolved into a sequence of subregions. Specific characteristics may be assigned to each subregion and a sequence of characteristics to further resolve the location of the sensor within the previously identified subregions. This may be followed by a similar division of the subregion into a subsubregions and so on.

Thus, the position of a sensor on a display screen may be determined with any desired level of granularity. The number of regions is limited only by the ability to resolve different characteristics such as colors, and to create regions of given size, and by the optical sampling size and ability to analyze the sequence of frames.

By increasing the sequence size, the number of colors may be decreased. Thus, in a system in which red luminance is a problem, a sequence of green and blue colors may be utilized exclusively to locate positions on the display.

In accordance with another embodiment of the present invention, shown in FIG. 2, a plurality of frames la may be subdivided into regions 12a-18a. In this case, a characteristic, such as a color assigned to each region 12a-18a, varies between only two values. The number of frames 10a in a location determining sequence is then increased. As an example, one may assign the sequence R-R-G-R-R to the region 12a, the sequence G-R-R-R-G to the region 14a, the sequence R-G-R-R-G to the region 16a, and the R-R-R-R-G to the region 18a. Thus, each region 12a-18a may have a sequence that is uniquely time coded.

The insertion of the position locating frames 10 need not be sequential with respect to the display of actual text or graphics frames. For example, the frames 10 used for position locating purposes may be interspersed with regular frames at any desired granularity. In other words, the position locating frames may be interspersed between every other regular frames, every 10th regular frame, or at some other rate, depending on the speed with which the detection can be (or needs to be) accomplished. In other embodiments, it may be desirable to rapidly display the position detecting frames in sequence at a speed that makes the position locating frames substantially undetectable by the user.

The present techniques may be applicable to any of a variety of conventional displays including cathode ray tubes, liquid crystal devices, and light emitting diode based display technologies as examples.

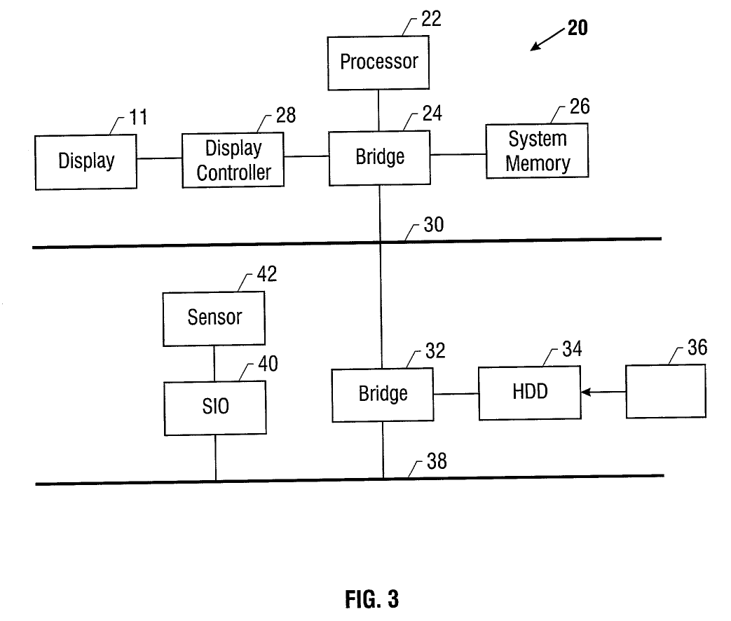

Referring to FIG. 3, a system 20 displays images and detects the position of a sensor 42 such as a light pen on a display 11. A processor 22 may be coupled to a bridge 24 in one embodiment. In such an embodiment, the bridge 24 may be coupled to a system memory 26 and a display 11 through a display controller 28. Similarly, in that embodiment, the bridge 24 may be coupled to a bus 30 in turn coupled to another bridge 32. Still continuing with the same embodiment, the bridge 32 may include a storage device 34 that stores a software program 36. The bridge 32 may also coupled through a bus 38 to a serial input/output (SIO) device 40 in turn coupled to a sensor 42. The sensor 42 may be what is conventionally called a light pen in one embodiment.

In another embodiment of the present invention, the light pen 42 may be coupled through a Universal Serial Bus, for example through an appropriate hub to the bridge 32. Of course, a variety of other computer architectures may be utilized to support the sensor 42.

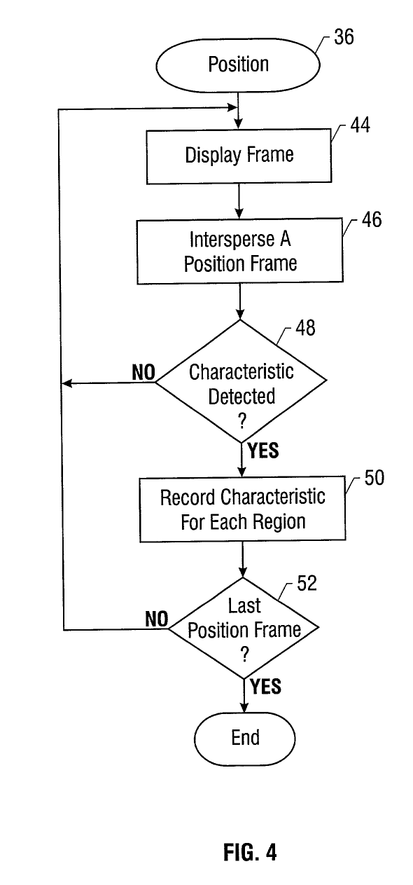

Referring to FIG. 4, a flow chart for the software 36, in accordance with one embodiment of the present invention, begins by displaying a conventional frame as indicated in block 44. After a conventional frame has been displayed, a position locating frame 10 or 10a of the type shown in FIGS. 1 and 2 may be interspersed within conventional frames, as indicated in block 46.

A check at diamond 48 determines whether a particular characteristic associated with regions 12-18 or 12a-18a has been detected. The characteristic may be a color, a gray scale value or some other detectable value associated with a particular region 12-18 or 12a-18a within the position locating frames 10.

When the characteristic has been detected for each region 12-18 or 12a-18a, the characteristic for each region is recorded as indicated in block 50. A check at diamond 52 determines whether the last position locating frame 10, 10a has now been displayed, for example interspersed with conventional frames. If so, the flow ends.

With embodiments of the present invention, a more reliable system for detecting the position of a sensor on a display screen may be realized. In some embodiments, displays that have luminance problems associated with particular colors (such as red) may be able to achieve relatively accurate position detection by simply eliminating the red color and using other colors available in the color gamut. In addition, colors with particularly good luminance values (such as blue) may be used preferentially in some embodiments. By using an iterative solution, involving progressively smaller regions having distinct characteristics, the accuracy of the system may be improved in some cases. Moreover, redundancy may be included wherein a given sequence of characteristic features may be repeated to ensure that the same result is obtained repetitively before providing a final answer to the system.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
resolving a display into at least two regions;
generating a different sequence of characteristic values in each region; and
resolving the position of a sensor with respect to said regions.

2. The method of claim 1 wherein resolving a display into at two regions includes resolving a display into at least four regions.

3. The method of claim 1 wherein generating a different sequence includes generating a different sequence of color values in each region.

4. The method of claim 3 including generating a different sequence of at least three color values.

5. The method of claim 3 including generating a different sequence of only two color values.

6. The method of claim 1 including displaying a series of frames and interspersing, among said frames, additional frames having at least two regions each displaying a sequence of characteristic values.

7. The method of claim 6 including displaying said additional frames in a fashion such that they are substantially undetectable by the user.

8. The method of claim 1 including generating a different sequence of characteristic values by displaying a time sequence of frames each including at least two regions, and each of said regions displaying a timed sequence of characteristic values.

9. The method of claim 8 including interspersing frames containing said characteristic values and frames not containing said characteristic values.

10. The method of claim 1 including developing a sequence using fewer characteristic values than the number of regions.

11. An article comprising a medium storing instructions that enable a processor-based system to:
resolve a display into at least two regions; and
generate a different sequence of characteristic values in each region.

12. The article of claim 11 further storing instructions that enable the processor-based system to resolve the position of a sensor with respect to said regions.

13. The article of claim 11 further storing instructions that enable the processor-based system to resolve the display into at least four regions.

14. The article of claim 11 further storing instructions that enable the processor-based system to generate a different sequence of color values in each region.

15. The article of claim 14 further storing instructions that enable the processor-based system to generate a different sequence of at least three color values in each region.

16. The article of claim 14 further storing instructions that enable the processor-based system to generate a different sequence of only two color values in each region.

17. The article of claim 11 further storing instructions that enable the processor-based system to cause a series of frames to be displayed while interspersing, among said frames, additional frames having at least two regions each displaying a sequence of characteristic values.

18. The article of claim 11 further storing instructions that enable the processor-based system to generate a different sequence of characteristic values by displaying a time sequence of frames each including at least two regions, and each of said regions displaying a time sequence of characteristic values.

19. The article of claim 18 further storing instructions that enable the processor-based system to intersperse frames containing said characteristic values and frames not containing said characteristic values.

20. A system comprising:
a processor;
a memory coupled to said processor, said memory storing instructions that enable the system to resolve a display into at least two regions and generate a different sequence of characteristic values in each region.

21. The system of claim 20 including a display coupled to said processor.

22. The system of claim 21 wherein said storage stores instructions that enable the system to resolve the position of a sensor with respect to said regions.

23. The article of claim 20 wherein said storage stores instructions that enable the system to resolve the display into at least four regions.

24. The system of claim 21 wherein said storage stores instructions that enable the system to generate a different sequence of color values in each region.

25. The system of claim 24 wherein said storage stores instructions that enable the system to generate a different sequence of at least three color values in each region.

26. The system of claim 24 wherein said storage stores instructions that enable the system to generate a different sequence of only two color values in each region.

27. The system of claim 20 wherein said storage stores instructions that enable the system to cause a series a frames to be displayed while interspersing, among said frames, additional frames having at least two regions each displaying a sequence of characteristic values.

28. The system of claim 20 wherein said storage stores instructions that enable the system to generate a different sequence of characteristic values by displaying a time sequence of frames each including at least two regions, and each of said regions displaying a time sequence of characteristic values.

29. The system of claim 20 including a sensor coupled to said processor.

30. The system of claim 29 wherein said sensor is a light sensor that detects a characteristic value in the form of light.
